(19) United States
(12) Patent Application Publication
(10) Pub. No.: US 2010/0284586 A1
(43) Pub. Date: Nov. 11, 2010

(54) SEGMENTATION OF MICROCALCIFICATIONS IN A MAMMOGRAPHIC IMAGE

(75) Inventors: Matthias Elter, Erlangen (DE); Dirk Steckhan, Munich (DE); Stephan Rupp, Erlangen (DE); Timo Schlarb, Fuerth (DE)

Correspondence Address: SCHOPPE, ZIMMERMANN , STOCKELER & ZINKLER;C/O KEATING & BENNETT, LLP, 1800 Alexander Bell Drive, SUITE 200, Reston, VA, 20191, US

(73) Assignee: Fraunhofer-Gesellschaft zur Foerderung der angewandten Forschung e.V., Munich (DE)

(21) Appl. No.: 12/746,294

(22) PCT Filed: Dec. 3, 2008
(86) PCT No.: PCT/EP2008/010240

§ 371 Date: Jun. 30, 2010

(30) Foreign Application Priority Data
Dec. 7, 2007 (DE) 10 2007 058 968.0

(51) Int. Cl. G06K 9/00

(52) U.S. Cl. 382/128

(57) ABSTRACT

Apparatus for segmenting microcalcifications in a mammographic image having a bandpass filter for bandpass filtering the mammographic image obtaining the filtered mammographic image, a marker and a processor for individual processing. The marker marks image points in the filtered mammographic image as potential regions of microcalcifications when a they exceed or fall below a predetermined threshold. The processor for individual processing processes one of the regions of adjacent marked image points for changing an extension of the one region for illustrating a segmentation of microcalcifications.

### BACKGROUND OF THE INVENTION

The present invention relates to an apparatus and a method for segmenting microcalcifications in a mammographic image, and in particular to the segmentation of microcalcifications in mammographic images for computer-aided diagnosis of breast cancer.

Breast cancer is the most frequent type of cancer for women in the western hemisphere. One in ten women in the western hemisphere develops breast cancer during the course of her lifetime. Nowadays, early detection and diagnosis is still the most effective possibility for reducing the death rate for this type of cancer. Mammographic images are an effective means for enabling early detection of small tumor diseases that cannot be felt. One disadvantage in interpreting mammograms, however, is the difficulty in differentiating between benign and malignant lesions—even for experts in mammography it is a challenge to correctly interpret the form of the lesion.

The early diagnosis of the disease considerably improves the chances of survival of the woman affected. Digital X-ray mammography is the most effective technique for diagnosing breast cancer tumors at an early stage. For simplifying the diagnosis and also for improving the detection rate, frequently, systems for computer-aided diagnosis (CAD) of mammographic images are used. These systems indicate suspicious regions in mammograms to the radiologist by means of automatic analysis of mammographic images by image processing methods and offer support in the diagnosis of the lesions—whether they are benign or malignant tumors.

An important group of breast lesions found in mammographic images are so-called microcalcifications. These are small calcium deposits in the breast tissue, frequently occurring in groups, which indicate early stages of breast tumors. For generating an automatic diagnosis suggestion, the individual calcium particles are usually separated automatically from the background tissue. This separation of calcium particles from the respective background tissue (or background) is also called segmentation. Subsequently, calculation and evaluation of the shape and distribution features of the microcalcifications can be performed. The segmentation results of conventional fully automatic methods for separating individual calcium particles from the background are often insufficient.

In clinical practice, the usage of mammographic images frequently shows a series of weaknesses. Microcalcifications occurring in groups or clusters are, however, an early sign for breast cancer, but the differentiation between benign and malignant clusters of microcalcifications based on their occurrence in mammographic images is often a very difficult task. Hence, when using these conventional methods, it is not surprising that typically only 15% to 20% of breast biopsies carried out due to calcifications confirm malignancy. In the US, for example, a malignant pathology has later been confirmed in only 15-30% of the performed breast biopsies. This low positive prediction value (PPV) for mammographic images with regard to the diagnosis of calcium deposits (occurring in groups) implies many biopsies performed unnecessarily on benign calcifications, i.e. far too many breast biopsies are performed on patients with benign groups of microcalcifications. The unnecessary biopsies cause a large mental and also physical stress for the respective patient.

In the past, options or methods in computer-aided diagnosis of microcalcifications have been suggested with the aim of increasing reliability. These conventional methods use, for example, segmentations of the digital picture of the mammographic images by using so-called wavelets, with the help of which in particular localized structures can easily be detected. These conventional methods that are performed fully automatically use a threshold analysis where a global threshold (for the whole picture or a whole picture region) is determined by the computer, with the help of which microcalcifications are to be differentiated from other structures of the background.

Effective automatic classifications of microcalcifications, i.e. the division into benign and malignant calcifications, are based on a good segmentation of individual calcium deposits or calcium particles. The conventional methods are based on fully automatic segmentation methods for individual calcium deposits. Since, however, none of these fully automatic methods showed an optimum result for segmentation, there is a need for further methods for improving the reliability of classifications of microcalcifications and, hence, the results. It follows that a novel computer-aided diagnosis approach (CADx) is desirable.

### SUMMARY

According to an embodiment, an apparatus for segmenting microcalcifications in a mammographic image may have: a bandpass filter for bandpass filtering the mammographic image for obtaining the filtered mammographic image; a means for marking image points in the filtered mammographic image which exceed or fall below a predetermined threshold, for marking potential regions of microcalcifications; and a means for individual processing of one of the potential regions of adjacent marked image points for changing an extension of the one potential region for obtaining a segmentation of microcalcifications, wherein the means for individual processing is implemented to manually enlarge or reduce a region of a microcalcification by means of a local change of the predetermined threshold in surroundings of the microcalcification.

According to another embodiment, an apparatus for segmenting microcalcifications in a mammographic image may have: a structural element sampling filter for filtering the mammographic image to obtain a filtered mammographic image; means for marking image points in the filtered mammographic image exceeding or falling below a predetermined threshold for marking potential regions of microcalcifications.

According to another embodiment, a method for segmenting microcalcifications in a mammographic image may have the steps of: bandpass filtering the mammographic image for obtaining a filtered mammographic image; marking image points in the filtered mammographic image exceeding a predetermined threshold as a potential region of a microcalcification; individually processing clusters of adjacent marked image points for changing an extension of clusters such that the clusters represent a segmentation of microcalcifications, wherein the individual processing is performed such that a region of a microcalcification is manually enlarged or reduced by means of a local change of the predetermined threshold in surroundings of the microcalcification.

Another embodiment may have a computer program comprising a program code for performing the method for segmenting microcalcifications in a mammographic image, the method having the steps of: bandpass filtering the mammographic image for obtaining a filtered mammographic image; marking image points in the filtered mammographic image exceeding a predetermined threshold as a potential region of a microcalcification; individually processing clusters of adjacent marked image points for changing an extension of clusters such that the clusters represent a segmentation of microcalcifications, wherein the individual processing is performed such that a region of a microcalcification is manually enlarged or reduced by means of a local change of the predetermined threshold in surroundings of the microcalcification, when the computer program runs on a computer.

According to another embodiment, a method for segmenting microcalcifications in a mammographic image may have the steps of: sampling the mammographic image by means of structural elements, and subtracting a background obtained in this manner from the mammographic image for obtaining a high-pass filtered mammographic image; low-pass filtering the high-pass filtered mammographic image for filtering out high frequent noise portions and for obtaining a filtered mammographic image; and marking image points in the mammographic image exceeding or falling below a predetermined threshold, for marking potential regions of microcalcifications.

Another embodiment may have a computer program comprising a program code for performing the method for segmenting microcalcifications in a mammographic image, the method having the steps of: sampling the mammographic image by means of structural elements, and subtracting a background obtained in this manner from the mammographic image for obtaining a high-pass filtered mammographic image; low-pass filtering the high-pass filtered mammographic image for filtering out high frequent noise portions and for obtaining a filtered mammographic image; and marking image points in the mammographic image exceeding or falling below a predetermined threshold, for marking potential regions of microcalcifications, when the computer program runs on a computer.

The present invention is based on the knowledge that segmentation of microcalcifications can be obtained by first performing bandpass filtering of a picture (mammographic image), and subsequently, individual processing of the bandpass-filtered images can be performed in one or several steps. As a result, segmentation of microcalcifications is obtained, which can, optionally, be further examined in an evaluation unit for predicting the nature of the microcalcifications (benign or malignant) with high probability.

The size of individual calcium particles (microcalcifications) can vary in a range between 0.1 to 1 mm, wherein the calcification particles generally show a high degree of locality. Thereby, the high locality shows in the above-described high edge steepness. Conventional methods for segmentation are based on the fact that microcalcifications appear in the picture as a region with high space-like frequencies. Wavelet-transformations offer the optimum possibility to determine regions with high space-like frequency proportions in a picture, and hence, form the basis for conventional detection mechanisms for microcalcifications.

Correspondingly, in embodiments, the bandpass filter can also be based on wavelet segmentation and be taken over fully automatically by a computer or a computer program, respectively. The subsequent individual processing can be performed by a means where for example, a threshold is selected such that as many calcifications as possible and as little noise as possible appears on the picture. Further, in the means for individual processing, certain microcalcifications can be enlarged or reduced, e.g. when the radiologist assumes that they are insufficiently illustrated in the image. The means for individual processing can also be used in that certain microcalcifications or particles are deleted or even added, or that a particle is divided, so that two separate microcalcifications occur in segmentation. These processing steps, however, can be performed individually by a radiologist or a doctor, such that they are performed both for a whole region with calcium deposits and also for certain sub-regions including microcalcifications.

Hence, embodiments of the present invention describe a semi-automatic method for segmentation of microcalcifications from a background tissue. With the semi-automatic approach necessitating a certain degree of interaction of the radiologist in contrary to the known fully automatic method, the segmentation results can be significantly improved in comparison with fully automatic methods. As has been mentioned, this segmentation of individual calcium particles can be gradually improved based on a fully automatic initial segmentation by intuitive interaction options of the radiologist or doctor. The optimized segmentation obtained in this manner results in an increase of the extracted form and distribution features (e.g. describing the morphology and distribution of the calcium particles), which again results in an improvement of a diagnosis suggestion (benign or malignant) of the CAD device.

Based on a digital database of mammographic images, it is possible to determine the performance of embodiments of the present invention for segmentation by using the respective regions (ROI=regions of interest) including benign or malignant clusters of microcalcifications. This can occur, for example, by using a so-called support vector machine and an ROC analysis (ROC=receiver operating characteristics). The resulting ROC performance is very promising and the semi-automatic segmentation shows a significantly higher performance (detection rate) than is the case in comparable fully automatic systems.

Embodiments of the present invention are based on semi-automatic segmentation of individual calcium deposits or calcium particles, feature extraction and further on clinical data and the classification by using a support vector machine. The performance of embodiments of the present invention can be determined with the help of the digital database for mammographic images (DDSM=digital database for screening mammography) by using a so-called Leaving-One-Out-Sampling and an ROC-curve analysis.

The above and other elements, features, steps, characteristics and advantages of the present invention will become more apparent from the following detailed description of the preferred embodiments with reference to the attached drawings.

### BRIEF DESCRIPTION OF THE DRAWINGS

Embodiments of the present invention will be detailed subsequently referring to the appended drawings, in which:

FIG. 1 is a schematic illustration of an apparatus according to an embodiment of the present invention;

FIGS. 2A, 2B is an intensity distribution and filtering of the same for a mammographic image along a space direction;

FIG. 3 is a filtered intensity distribution of a calcification with threshold analysis;

FIGS. 4A, 4B is intensity distribution prior and after the threshold analysis;

FIG. 5 is a calcification after an automatic bandpass filtering;

FIG. 6 is an individual size adaptation of a calcification;

FIG. 7 is a division of a calcification into two parts;

FIG. 8 is a region of a mammographic image with a plurality of candidates for calcifications;

FIG. 9A-9D is a gradual analysis of the region having calcifications as illustrated in FIG. 8, according to embodiments and

FIG. 10 is an illustration of the rolling ball method and the rolling ball bandpass filtering.

### DETAILED DESCRIPTION OF THE INVENTION

Regarding the subsequent description, it should be noted that in the different embodiments equal or similar functional elements or structures have the same or similar reference numerals, and hence the descriptions of these functional elements and the different embodiments are interchangeable.

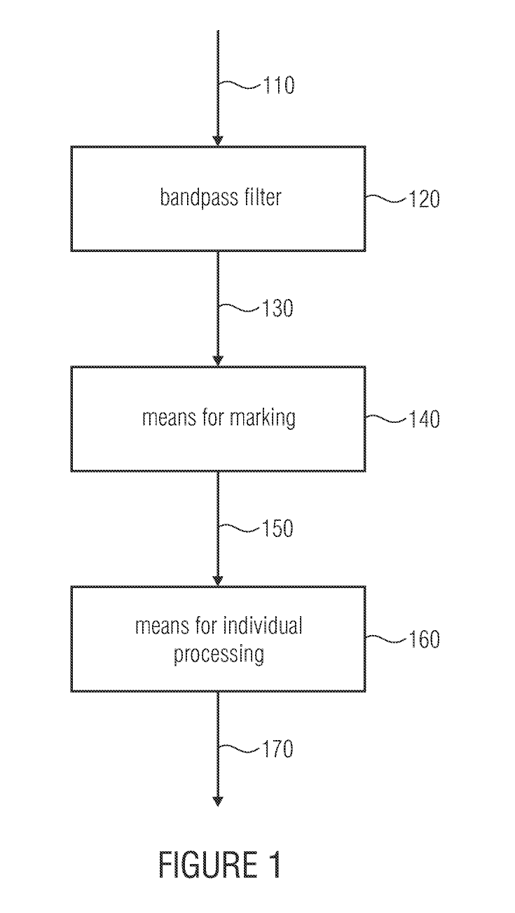

FIG. 1 shows a schematic illustration of an apparatus for segmenting microcalcifications 105 in a mammographic image 110, having a bandpass filter 120, wherein the bandpass filter 120 performs bandpass filtering of the mammographic image 110 for obtaining a filtered mammographic image 130. The filtered mammographic image 130 is supplied to a means for marking 140, which generates a marked mammographic image 150 from the same. Finally, the marked mammographic image 150 is input into a means for individual processing 160, wherein the means for individual processing 160 generates segmentation 170 from the marked mammographic image 150.

The means for marking 140 marks an amount of image pixels in the filtered mammographic image 130 as a potential region of microcalcification exceeding or falling below a predetermined threshold S (depending on the definition of the threshold S). The means for individual processing 160 changes, for example, the extension of clusters of adjacent marked image points, such that the clusters of image points represent a segmentation of microcalcifications. Changing the extension can, for example, include enlarging, reducing, or also generating or deleting potential microcalcifications. Here, a differentiation has to be made between the clusters of image points relating to a potential microcalcification and the clusters of microcalcifications. Further, it is possible that individual processing can include dividing a potential microcalcification into two separate microcalcifications.

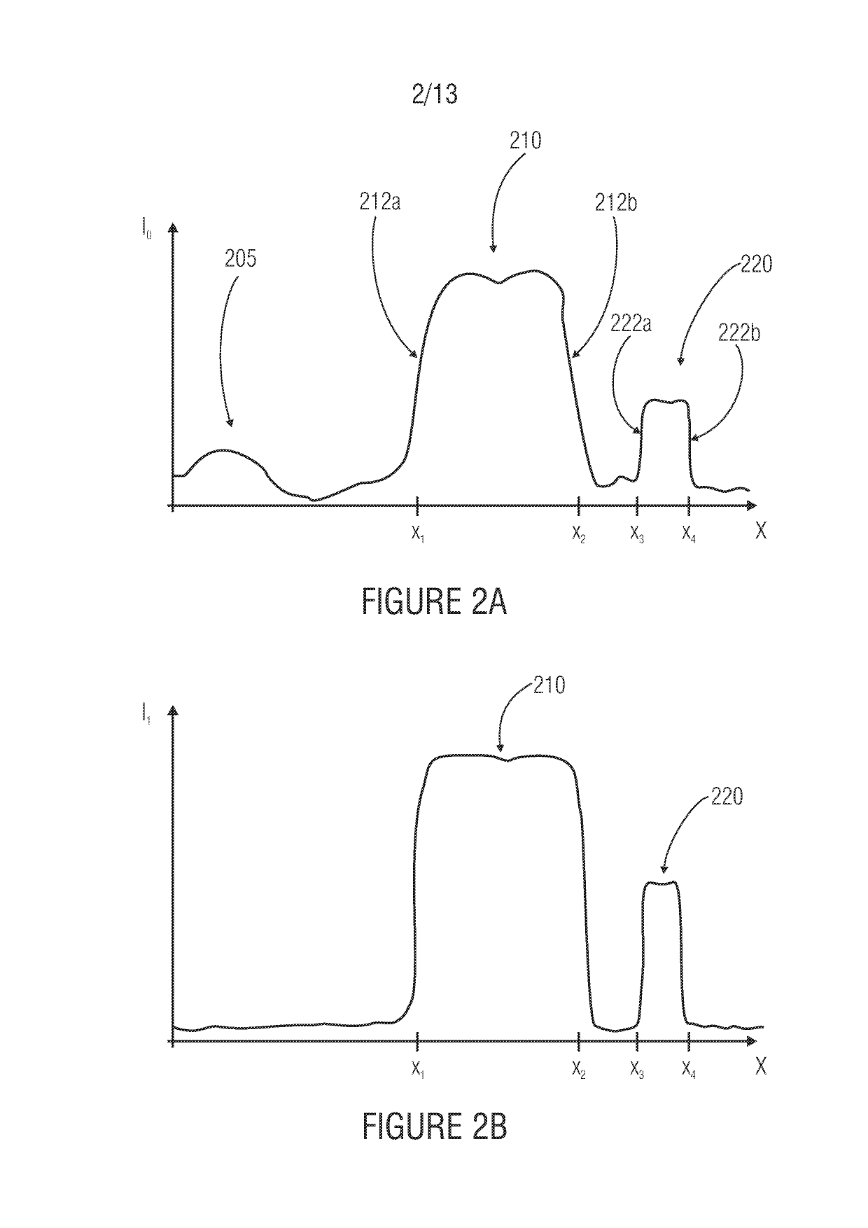

FIGS. 2A and 2B show intensity distributions of a mammographic image along a space direction x, wherein the intensity distribution I₀ in FIG. 2A is shown prior to bandpass filtering and the intensity distribution I₁ in FIG. 2B after bandpass filtering. The second space-like direction has been neglected in the illustrations, wherein it has to be considered that the analysis should be performed in a two-dimensional manner, such that an area-like illustration of potential microcalcifications is enabled.

The intensity distribution I₀ in FIG. 2A shows three maxima, a first maximum 205, a second maximum 210, and a third maximum 220. The second maximum 210 lies between the values of x₁ and x₂, and has a first edge 212a and a second edge 212b, between which the maximum is formed. The third maximum 220 has a third edge 222a at the x-value x₃ and a fourth edge 222b at the x-value x₄, between which the third maximum 220 is formed. Thereby, the second maximum 210 is larger than the third maximum 220.

FIG. 2B respectively shows a respectively bandpass-filtered intensity distribution I₁, wherein the bandpass filtering has been performed such that regions with only weak variations where the intensity only changes slightly have been filtered out. On the other hand, regions with strong intensity variations are maintained. Correspondingly, FIG. 2B shows first and second edges 212a and 212b of the second maximum 210, and also third and fourth edges 212a and 212b of the third maximum 220. Since the regions between the edges (e.g. for x₁≦x≦x₂ and x₃≦x≦x₄) represent potential calcifications, these regions have not been filtered out during bandpass filtering, but have also been marked respectively in the respectively filtered intensity distribution I₁. Accordingly, the filtered intensity distribution I₁ shows an increasing value starting from the value x₁, which again falls at the value x₂, so that the second maximum 210 has been identified between x₁ and x₂ as potential microcalcification. The same has been performed for the third maximum 220, so that an intensity distribution I₁ also differing from zero is shown between values x₃ and x₄. On the other hand, the first maximum 205, having only a small edge steepness, has been filtered out.

Accordingly, filtering can be performed such that in the intensity distribution I₀ as shown in FIG. 2A, all those regions are neglected where the increase of the function I₀ in dependence on the direction x is below a determined threshold. High edge steepness (or high rise in the function) is shown in a Fourier Analysis as increased occurrence of proportions of high frequencies. Accordingly, bandpass filtering can be performed such that proportions of high frequencies are maintained and proportions of low frequencies are filtered out. This can be obtained, for example, in an appropriate manner by wavelet transformation for bandpass filtering. Since wavelet transformations can efficiently filter out a certain frequency range (for example high frequency and thus high edge steepnesses), they are particularly suited for the desired bandpass filtering. In a conventional Fourier-Analysis, this is not the case.

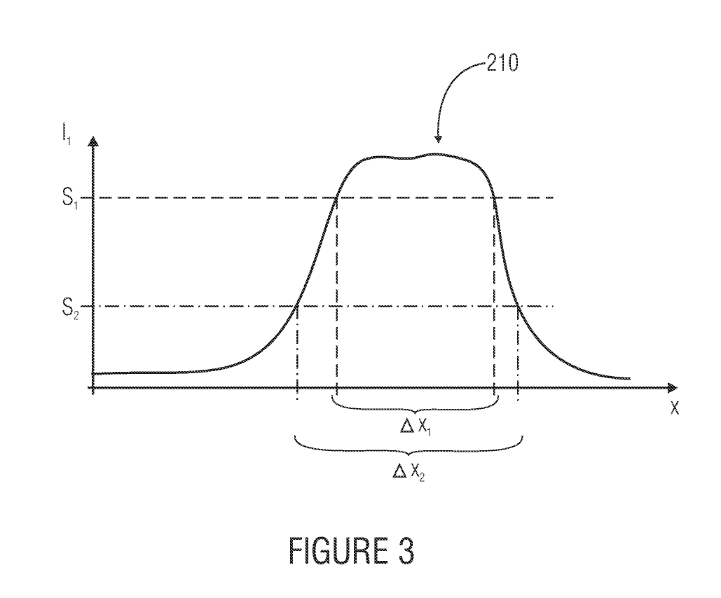

FIG. 3 shows an example for a filtered intensity distribution I₁ in dependence on a space-like direction x, as it is input, for example, in the means for marking 140.

FIG. 3 shows how the means for marking 140 marks potential microcalcifications in the filtered intensity distribution I₁ by means of a threshold S. Thereby, microcalcifications correspond to a maximum 210 in the intensity distribution I₁ (e.g. a white region in the mammographic image 110). In FIG. 3, two possible thresholds, a first threshold S₁ and a second threshold S₂ are shown. When using the first threshold S₁, the potential microcalcification 210 occurs within the space region Δx₁. When decreasing the threshold to a second threshold S₂, the microcalcification 210 occurs within the space region Δx₂. Hence, the space region of the microcalcification 210 has correspondingly increased during a decrease of the threshold.

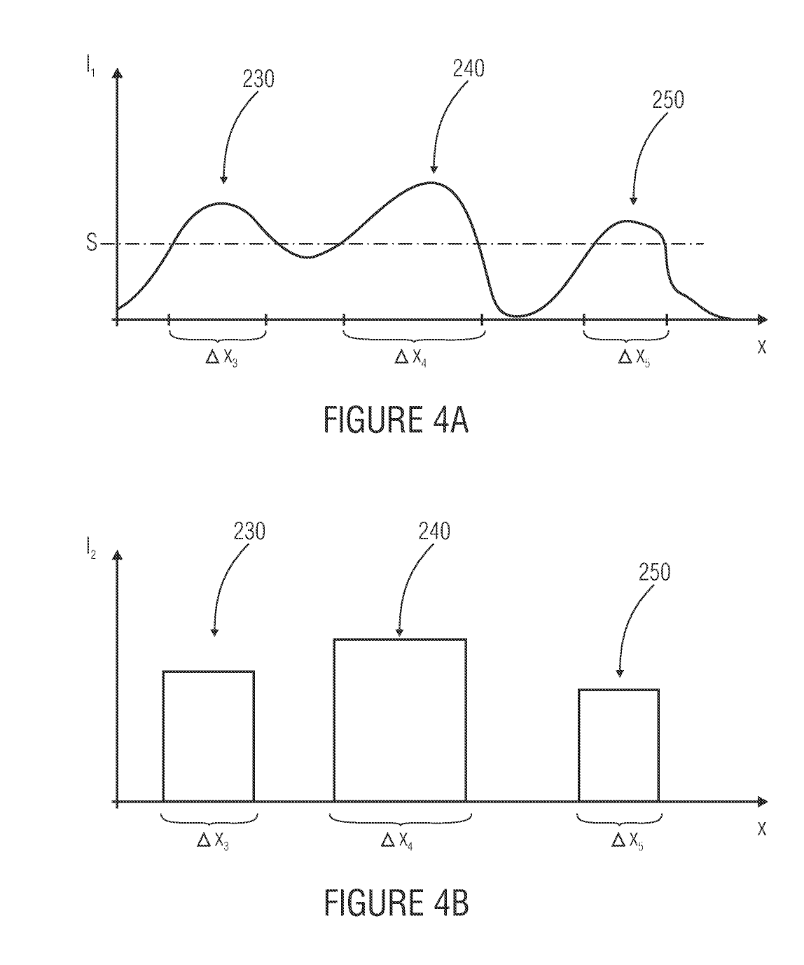

FIGS. 4A and 4B illustrate the result of the threshold analysis at is can be performed, for example, in the means for marking. FIG. 4A shows the filtered intensity distribution I₁ having a first maximum 230, a second maximum 240 and a third maximum 250, wherein the intensity distribution I₁ of the mammographic image is again illustrated along the x-direction. For the threshold analysis, a threshold S has been chosen such that the first maximum 230 appears as a microcalcification in a space region Δx₃, the second maximum 240 as a microcalcification along the space region Δx₄, and the third maximum 250 as a microcalcification in a space region Δx₅. All values of the intensity distribution I₁ lying below the threshold S have not been considered in the marked intensity distribution I₂ and instead, only those regions of the intensity distribution I₁ lying above the threshold S have been illustrated in the marked intensity distribution I₂, wherein the strength of the marked intensity distribution I₂ corresponds to a respective distance of the maximum from the threshold S.

In a representation for potential microcalcifications obtained in this manner, it can happen that regions belonging to one microcalcification are illustrated as two separate regions. For example, it can be the case that maximums 230 and 240 do not correspond to two separate microcalcifications, but that they both belong to one microcalcification.

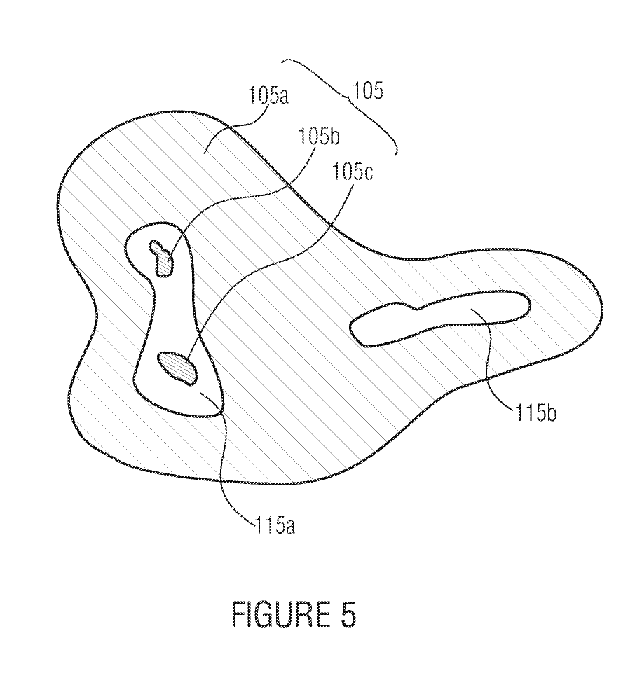

FIG. 5 shows an example of a microcalcification 105 illustrating that the threshold analysis as shown in FIGS. 4A and 4B has not been carried out in an ideal manner. In this regard, the microcalcification 105 has a first background section 115a and a second background section 115b, wherein the threshold analysis has the effect that this section has been mistakenly assigned to the background, although they are parts of the microcalcification 105. This is a typical example of a disadvantage of a globally selected threshold that, for example, does not consider local variations in the surroundings of a certain microcalcification. Accordingly, it is advantageous when such microcalcifications are “mended”. This mending can be performed such that, for example, regions 115a and 115b mistakenly marked as background disappear. It is also possible that within regions 115a, 115b mistakenly marked as background, islands of a further microcalcification show, which can also result as an artifact of the threshold analysis.

Such artifacts are difficult to detect for a fully automatic program, however, they represent no big challenge for a radiologist or doctor. Accordingly, it is advantageous when the threshold is correspondingly manually optimized. Manual optimization can be performed with regard to the global threshold, but also regionally in certain regions of the mammographic image 110, which are characterized, for example, by particularly strong noise. In this manual readjustment, a trade-off has to be found between detecting as many microcalcifications 105 as possible, but on the other hand, suppressing the noise as much as possible. One example for noise can be regions 115a, 115b, mistakenly assigned to the background.

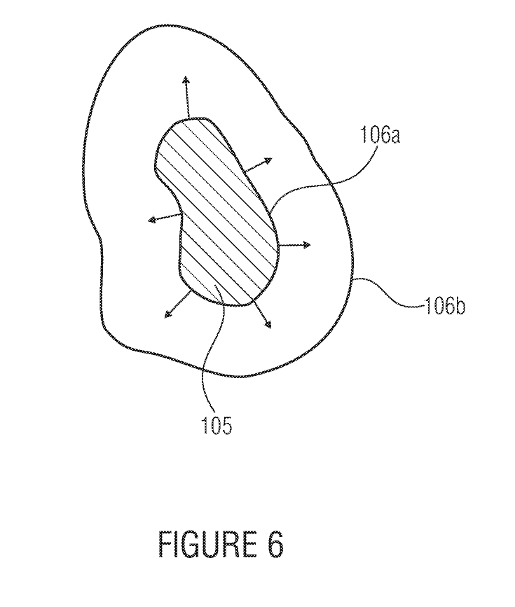

FIG. 6 shows an embodiment where a region marked as microcalcification 105 is individually changed with regard to its size so that an outer boundary curve 106a of the region 105 is enlarged, and the resulting microcalcification 105 has an enlarged boundary curve 106b. This enlargement of the microcalcification 105 can be performed, for example, by simple scaling. Another option for changing the size of calcium particles 105 is locally lowering the respective threshold in the surroundings of the microcalcification 105 (see FIG. 3). The surroundings can be flexibly adjustable (e.g. by a certain distance from the boundary curve of the microcalcification 105), or can be markable by means of a computer mouse. Scaling can be performed by length scale change or also by growth of the region, a so-called region growing technique.

The change in size of the microcalcification can, for example, be performed for the islands 105b and 105c shown in FIG. 5, such that the regions 115a and 115b marked as background disappear. It is also possible that the change in size is performed such that a microcalcification 105 or also a region marked as background is correspondingly reduced or disappears completely, respectively. This can take place, for example, with the region 115b marked as background in FIG. 5. As a special case, it is further possible that a microcalcification is added, i.e. that at one point or at one region, where previously no microcalcification 105 was marked, a new microcalcification is formed. Vice-a-versa, an existing microcalcification can be reduced until it disappears completely.

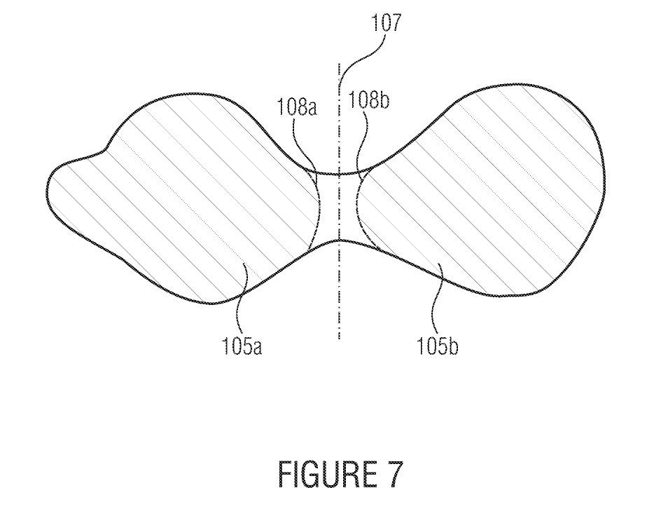

FIG. 7 shows a further option for individual corrective action on the marked microcalcification 105. With the example shown in FIG. 7 it is possible to divide a region marked as one microcalcification 105 into two separate microcalcifications 105a and 105b. This can, for example, happen when the radiologist or doctor determines that the shape of microcalcifications is atypical and that it is much more likely that the connection between the two microcalcification 105a and 105b is only an artifact of the threshold analysis or the bandpass filtering. The division can be made along a line 107 specified by the radiologist. In the division along the dividing line 107, a region can result which is not marked as microcalcification. This can be performed fully automatically by a computer program wherein further adaptations can be made such that the resulting first microcalcification 105a and second microcalcification 105b have an edge 108a and 108b, which is as smooth as possible (e.g. by conventional smoothing algorithms).

Since an individual microcalcification 105 can generally not provide an indication for a tumor disease, it is important to examine whole regions (ROI). In the following figures, this is shown based on a region 300, which is part of the mammographic image 110.

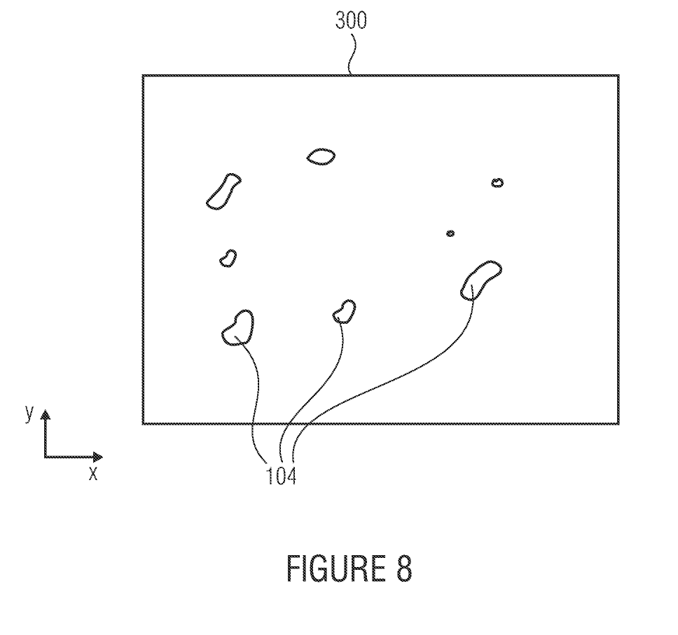

FIG. 8 first shows the region 300 having a series of candidates 104 for microcalcifications (a cluster of microcalcifications), which will be segmented in the following. Therefore, the mammographic image 110 is arranged in an x, y plane.

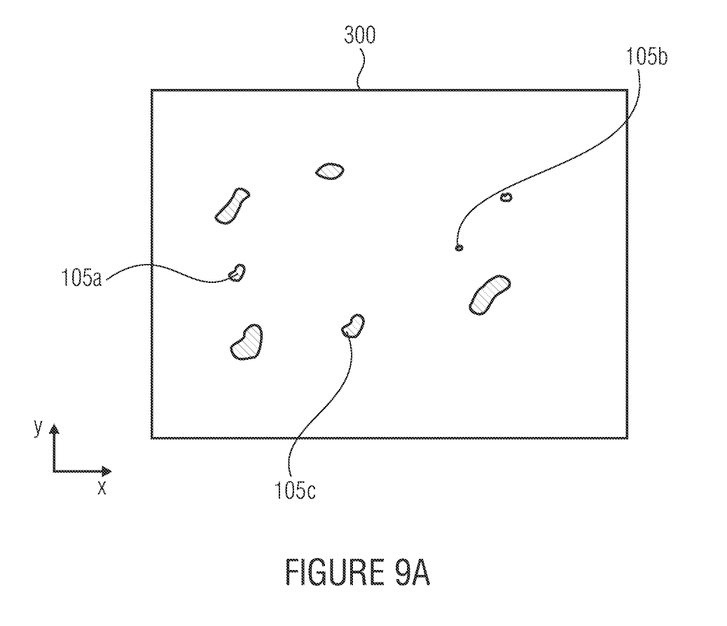

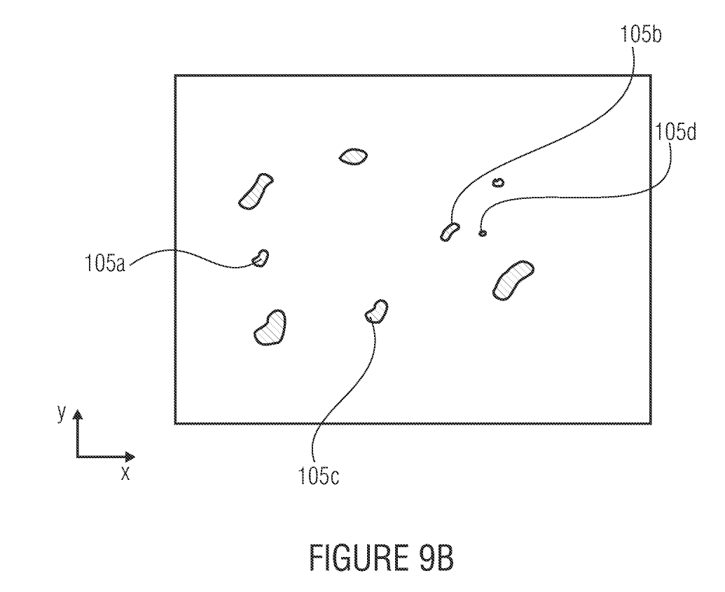

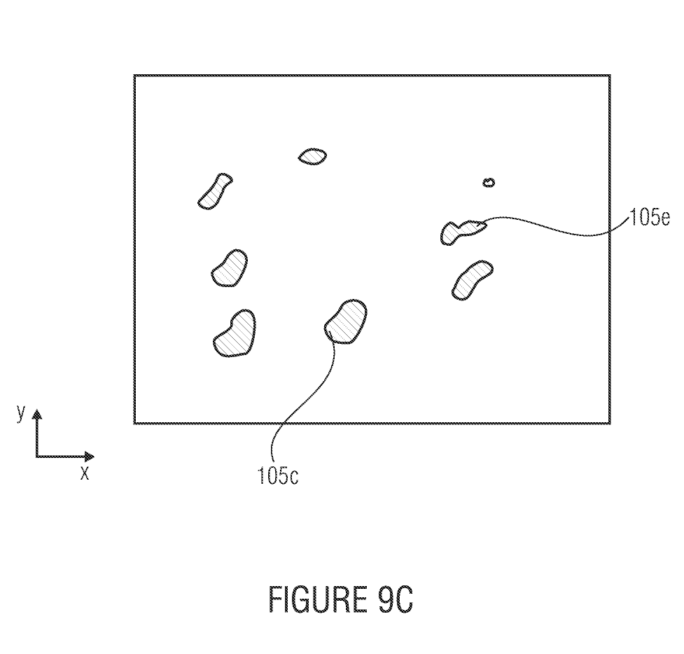

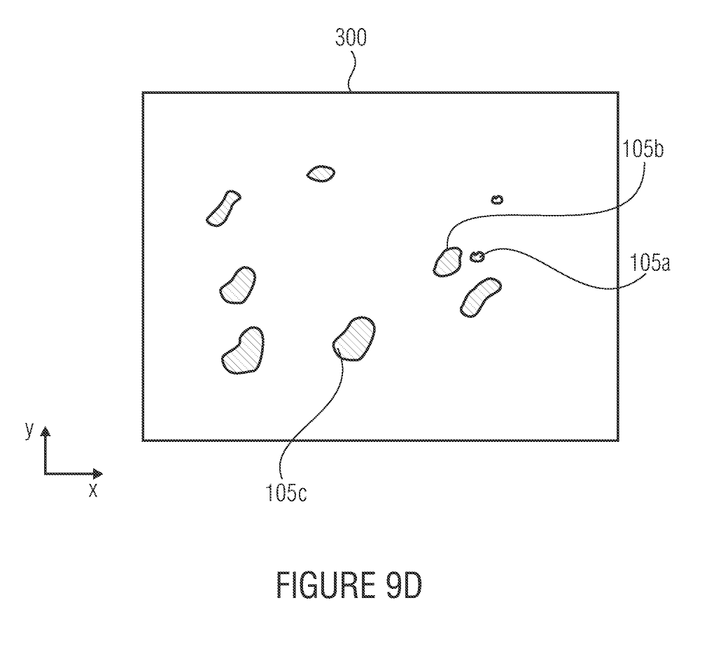

FIGS. 9A to 9D show a possible process sequence how the candidates of the microcalcification 104 can be identified and marked as microcalcification. The candidates 104 shown in FIG. 8 generally show no sharp edge, but are regions where microcalcifications are possibly formed.

FIG. 9A shows the result of bandpass filtering and marking of potential regions with microcalcifications 105. Hence, the same corresponds to the marked mammographic image 150 as output by the means for marking 140. FIG. 9A shows a series of marked microcalcifications 105a, 105b, 105c, . . . . Thus, FIG. 9A shows the result of automatic segmentation performed as a first step. The respective pixels of the segmented calcifications or calcium particles are marked correspondingly.

FIG. 9B shows a first step that can carried out with the means for individual processing 160. Thereby, the threshold S resulting in the marking of the microcalcification 105 is optimized correspondingly. Thereby, it shows that the microcalcification 105a shown in FIG. 9B has increased in size, and further, that a second adjacent microcalcification 105d has appeared besides the microcalcification 105b. FIG. 9B, hence, shows the first interactive step applied for segmentation and which includes increasing (or reducing) the threshold for the wavelet bandpass filtered image (e.g. via a mouse wheel).

FIG. 9C shows a further corrective action during individual processing where individual microcalcifications are enlarged or reduced—in the extreme case, even deleted or added. As one example, microcalcification 105e is shown, which has resulted in the course of enlarging the microcalcification 105b/105d from a microcalcification 105e. Further, the microcalcification 105c has been enlarged. The decision on which of the shown microcalcifications are illustrated mistakenly or insufficiently, may be taken manually by the radiologist or doctor so that he can correspondingly change the size of the respective microcalcification by simply marking a region or by clicking a mouse button. In the present embodiment, in this procedure the microcalcification 105b and 105d have merged to one microcalcification 105e.

Hence, FIG. 9C shows the improved segmentation which is still not perfect, since it does not yet represent the exact form of some particles. As described, individual particles can be enlarged or reduced further, for example, by clicking on these particles with the left or right mouse button. FIG. 9C shows a further artifact, which consists of the fact that, as a result of the previously performed step, two individual particles have mistakenly been merged into one large particle (calcification 105e). With the central mouse button, for example, by clicking on this mistakenly illustrated particle, an optimum dividing line can be generated and the particle can be divided into two individual particles.

FIG. 9D shows a further corrective action, where the microcalcification 105e resulting from enlargement, is again divided into two microcalcifications—the microcalcification 105b and the microcalcification 105d. The separation can be made as described in FIG. 7, wherein the radiologist decides whether the division is useful or not.

Hence, FIG. 9D shows a segmentation 170 obtained by individual corrective action from the originally marked mammographic image 150. The segmentation 170 can subsequently be supplied to an evaluation unit for further analysis and diagnosis with regard to benignancy or malignancy of microcalcifications 105.

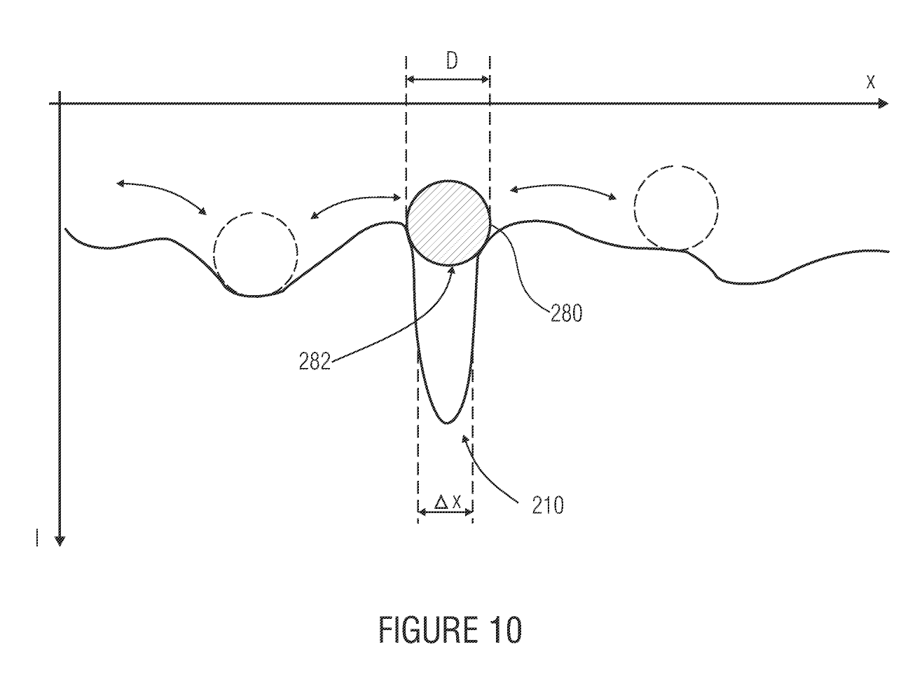

In the previous embodiments, pre-bandpass filtering has been performed by selecting suitable spectral bands of the wavelet transform. FIG. 10 shows a further embodiment of the present invention wherein the rolling ball method is used for performing bandpass filtering in addition or as an alternative to wavelet transformation. Thereby, again, in FIG. 10, the intensity is shown as a function of a location variable x, wherein the representation in FIG. 10 has been mirrored along the x-axis compared to the illustrations in FIGS. 2 and 3 (reverse illustration). Hence, regions where the intensities I have a larger value, and can represent, for example, microcalcifications 105, are arranged further towards the bottom in the illustration of FIG. 10, and regions having lower intensities are closer to the x-axis and hence further towards the top in FIG. 10. Thereby, a microcalcification 105 is a minimum 210 in the illustration.

Applying the rolling ball method to the mammographic image of interest results in a low-pass filtered version of the mammographic image describing a slowly changing background of the image, which will then be subtracted from the mammographic image for reaching a high-pass filtered version where the background has been removed. In particular, the result of applying a rolling ball method to a mammographic image can be imagined as a 3-dimensional area, for example described by the center of the ball 280, when the same is rolled with a diameter D along the 3-dimensional intensity distribution I spanned between column and row direction. Depending on the diameter D of the ball, the result is more or less low-pass filtered.

As can be seen in FIG. 10, the diameter D can be adjusted, for example, such that the ball 280 can be constantly rolled across the intensity distribution I (x) outside the microcalcification 105, while the microcalcification 105 cannot be sampled by the ball 280. In other words, this means that the intensity distribution I outside the microcalcification 105 can be associated with a surface point of the ball 280, which is, however, not possible within the microcalcification 105 due to the diameter D of the ball 280, which is larger than the extension Δx of the microcalcification 105.

Hence, all points not belonging to the microcalcification 105 (i.e. lying outside of the minimum 210) and hence, belonging to background tissue, can be marked. After marking all points that can be sampled by the ball 280 (i.e. across which the ball 280 can roll), or after sampling the area I with the ball 280, the obtained picture describing the curve of the center of the ball can be subtracted from the original picture, possibly by additionally subtracting a remaining steady component or average value, respectively, of the resulting differential picture. As a result, an illustration is obtained where signals are subtracted from the background tissue and hence, microcalcification 105 appear more clearly.

It is obvious that for effectively subtracting the background tissue, the diameter D of the ball 280 should be selected large enough. In particular, the diameter D should be larger than a typical extension Δx or better a maximum extension of a microcalcification 105 (i.e. larger than Δx₂ of FIG. 3.) Hence, by this method, it is also possible to clearly identify microcalcifications 105 in the original mammographic image 300.

Hence, the rolling ball method determines a smooth or continuous background that can be removed from the picture (mammographic image) and marks localized structures, such as microcalcifications 105. As mentioned above, the rolling ball method can be illustrated such that the intensity distribution in FIG. 10 is considered as a 3-dimensional surface, by which the pixel value (intensity value I) of the image appears as height or depth, respectively, and the x and y values appear as base area. The ball 280 can be rolled across the area in a 3-dimensional space obtained in this manner, having heights and depths, across the rear of the intensity distribution, and generates a background image where all points/regions of the intensity distribution are marked, across which the ball 280 can be rolled.

This background image can be subtracted from the original image of the mammographic image 110 such that low-frequency or slowly changing proportions can be removed from a tissue in the mammographic image 110. Instead of a ball, a general structural element can be used, by which slowly varying proportions in the intensity distribution can be sampled, which does not necessarily need to roll on the area corresponding to the picture. Hence, the method can also be referred to as sample filtering by means of a structural element or structural element sample filtering. Since the mammographic image 300 represents a 2-dimensional image, the rolling ball method can, for example, be modified, so that instead of the ball in a 3-dimensional form, a pen, for example, with a semi-ball as a sampling tip can be used.

Optionally, subsequently, low-pass filtering can be performed, such as Gaussian low-pass filtering for removing high-frequency proportions originating, for example, from noise, can be removed from the picture. Hence, overall, bandpass filtering is obtained. As mentioned, the radius of the rolling ball 280 should be selected at least as large as the radius of the largest object in the picture (here microcalcification), which is not part of the background or as large as that microcalcification diameter below which a predetermined percentage, such as 95%, of the microcalcification diameters lies.

Although the just-described form of mammographic image bandpass filtering can also be used without the semi-automatic segmentation described in the above embodiments, such as for subsequent segmentation of microcalcification by means of an automatically determined threshold, the mammographic image bandpass-filtered in this manner can result in a very accurate segmentation together with the above-described user input options. Thereby, adjustability of the bandpass filter boundaries can be provided, for example, by means of the rolling wheel of the computer mouse, for example, by varying the dimensions of the structural element or the diameter of the ball corresponding to the rotation of the wheel, and by showing the updated results until a current adjustment is confirmed by the user, e.g. by means of the left mouse button.

Further specifications of embodiments of the inventive procedure during segmentation and possible classification of microcalcification 105 can also be summarized as follows.

Conventional methods for segmentation are based, as has already been described above, on the fact that microcalcifications appear in the picture as a region with high space-like frequencies. Wavelet transformations offer the optimum possibility of determining regions with high space-like frequency proportions in a picture, and hence, they form the basis for conventional detection mechanisms for microcalcifications. The compactness and high regularity of wavelets of the Daubechies family makes these wavelets an obvious choice in finding calcifications. Hence, it is also advantageous for embodiments of the present invention to use a bandpass filter based on the wavelet transformation by means of Daubechies-6-wavelets. Thereby, first, the area having clusters of microcalcifications is divided into subbands by using wavelet transformation. Subsequently, those bands corresponding to space-like frequencies, which are above or below a certain space-like frequency typical for calcification or calcium particles, are neglected (filtered out). Subsequently, retransformation of the wavelet transformation is performed and as a result, a bandpass filtered version of the original image, i.e. the filtered mammographic image 130 is obtained. The obtained bandpass filtered original image includes not only the microcalcifications, but unfortunately also other picture structures, such as a noise having accidently the same space-like frequencies like a typical calcium particle.

Fully automatic segmentation of calcium particles can be performed by applying a threshold S, which is normally locally adaptive, to the bandpass filtered picture 130. In most cases, however, the fully automatic segmentation is far from perfect, and instead, as has been stated, an interactive segmentation step as an extension for automatic segmentation is useful. Hence, the complete segmentation process comprises an automatic first step and an interactive second step, and is thus semi-automatic.

The above briefly described interactive corrective action can be summarized as follows, or be further specified by using a computer mouse as part of the means for individual processing.

First, in the suggested interactive extension, the threshold S used for segmentation for separating calcifications from a background is optimized by a doctor/radiologist (or another user). Optimization can be performed, for example, by means of a computer or a mouse wheel. By interaction it is possible to find an optimum global threshold that can be applied to the specified region (ROI) for making a diagnosis. For example, by rotating the mouse wheel, the used threshold can be continuously changed until the user has obtained a desired result.

However, in most cases, the global threshold will not be optimum for every particle within a group. Hence, further corrective action is desirable for obtaining a good segmentation result. It has shown that a simple to use and still very effective method for improving the segmentation of individual particles is automatically enlarging or reducing certain regions. In detail, it is possible that individual particles are enlarged or reduced by clicking with the right or left mouse button on the respective particle or the respective region. The exact amount and direction of growth (i.e. in what spatial direction the particle grows) or the reduction of the given segmentation or given region of particles can be controlled, for example, automatically, by using the so-called region growing technique.

By using the two above-described interaction options, the size of the segmentation region of a cluster of particles can be optimized easily and effectively by a doctor. However, two problems remain. On the one hand, the particles actually representing microcalcifications are not illustrated in the image, and on the other hand, it is possible that the noise has mistakenly caused marking of particles (microcalcifications), in particular in the initial segmentation step. Both problems can be solved in that the doctor deletes individual particles—for example by clicking with the right mouse button on the respective particle, which is smaller than a given size. Further, the doctor can generate new calcium particles, for example by clicking on the left mouse button in the region or on the location having no calcium particles.

A further problem, which has also been indicated above, is given by the fact that it sometimes happens that the original segmentation had the result that two particles actually representing separate particles appear in the picture as a uniform combined particle. This problem will be solved by dividing one particle into two particles, for example in that the doctor clicks on the particle with the central mouse button, such that a dividing line results between the two particles that are to occur. A computer program can for example, automatically generate the dividing line. Finally, by automatic analysis, the form or boundaries of the resulting particles can be optimized.

In further embodiments, based on the obtained segmentation 170, features can be extracted, based on which a diagnosis becomes possible whether the calcifications are benign or malignant calcium particles. Many features can be obtained from the segmentation of the individual particle clusters. Thereby, most features comprise the morphology, but the distribution of the individual particles can also be extracted. Regarding the form, for example, a differentiation can be made between round or angular calcium particles, which can further be grouped in a tight manner or arranged along a line. Additionally, further clinical parameters, such as the age of the patient (that are for example included in the DDSM commentary) can be enclosed. Overall, it is possible to extract more than 30 features for a respective ROI region. Since the dimension of the feature vector obtained in this manner can be very high, a self-learning technique can be used for automatic selection of an optimum sub-space of features. An n-dimensional feature vector that can be obtained from a respective ROI region including calcification clusters represents a point in an n-dimensional vector space. Each of these data points belongs to one of two classes corresponding to either benign or malignant microcalcifications. The separation and hence classification of data can be obtained by finding an (n−1) dimensional hyper area optimally (i.e. with a maximum free boundary region) separating the benign from the malignant data points. As in a non-trivial case, often no optimum hyper area can be found, instead, a support vector analysis can be performed (by using a support vector machine). Thereby, the feature space maps into a higher dimensional space where the hyper area can easily be found. This can, for example be performed by a so-called kernel function. For many classification tasks, the support vector machine classifiers form good analysis tools, and also for embodiments of the present invention, a support vector machine represents a good classifier that can differentiate between benign and malignant clusters of calcifications.

For determining the performance of the classification of (a CADx approach for microcalcifications), leaving-one-out-sampling can be performed, which can be supplemented by an ROC-curve analysis. The area under the ROC-curve A_{z} is used as performance metric (measure for performance). It shows that the ROC calculation of the inventive method of the computer-aided diagnosis in fully automatic segmentation provides a value for the area below the ROC curve: A_{z}=0.76±0.01. On the other hand, for a semi-automatic segmentation, the area below the ROC curve is significantly higher, namely A_{z}=0.78±0.01 with a statistic significance of p<0.05.

For performance measurements, computer-aided diagnosis methods use, for example, mammographic images, which can be extracted from the digital databank for mammographic images (DDSM). The DDSM has mammographic images that have been digitalized means of different digital converters. The interesting marked ROI regions include malignant clusters of microcalcifications, which have been extracted from the DDSM database, and have been marked with “cancer_{—}01”, “cancer_{—}02”, “cancer_{—}05”, “cancer_{—}09”, “cancer_{—}15”. All ROI having benign microcalcifications have been marked with “benign_{—}01”, “benign_{—}04”, “benign_{—}06, “benign_{—}13” “benign_{—}14”. All in all, 530 ROI regions are extracted, 224 of which include malignant clusters verified by biopsies and the remaining 306 include benign clusters of microcalcifications.

In summary, embodiments of the present invention provide a computer-aided diagnosis enabling to determine the diagnosis of benign or malignant clusters of microcalcifications. Both the fully automatic and the inventive semi-automatic segmentation can be used for segmenting individual calcium particles from a background tissue. Based on the inventive segmentation, it is possible to extract a large number of features, which depend mostly on the morphology and also on the distribution of the individual calcium particles. Since the feature space has a high dimension, an automatic learning technique can be applied for finding an optimum sub-space of the features. The resulting feature vector is classified by means of a support vector machine. With the aid of a set of ROI regions including microcalcifications, which can be obtained from the DDSM database, the performance of the inventive method can be analyzed very well. The inventive method shows a very good ROC performance. This is particularly astonishing since systems using Bi-Rads attributes (Bi-Rads=breast imaging reporting and data system) show a significantly worse performance by using the same data, than is the case in the embodiments of the present invention. By using the semi-automatic segmentation, the ROC performance is significantly higher than is the case in comparable fully automatic segmentations. This shows that an easy to use interactive segmentation process involving a doctor or a radiologist does not only improve the quality of segmentation of the individual particles, but above this, improves the usefulness of the features that can be extracted based on the segmentation.

In particular, it should be noted that depending on the circumstances, the inventive scheme can also be implemented in software. The implementation can be made on a digital memory medium, in particular a disc or a CD with electronically readable control signals that can cooperate with a programmable computer system such that the respective method is performed. Generally, the invention also consists of a computer program product with a program code for performing the inventive method stored on a machine readable carrier when the computer program product runs on a computer. In other words, the invention can be realized as a computer program with a program code for performing a method when the computer program runs on a computer.

While this invention has been described in terms of several advantageous embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

1-27. (canceled)

28. Apparatus for segmenting microcalcifications in a mammographic image comprising:
a bandpass filter for bandpass filtering the mammographic image for acquiring the filtered mammographic image;
a marker for marking image points in the filtered mammographic image which exceed or fall below a predetermined threshold, for marking potential regions of microcalcifications; and
a processor for individual processing of one of the potential regions of adjacent marked image points for changing an extension of the one potential region for acquiring a segmentation of microcalcifications,
wherein the processor for individual processing is implemented to manually enlarge or reduce a region of a microcalcification by means of a local change of the predetermined threshold in surroundings of the microcalcification.

29. Apparatus according to claim 28, wherein the processor for individual processing is implemented such that the surroundings of the microcalcification where the predetermined threshold is locally changed can be marked by means of a computer mouse.

30. Apparatus according to claim 28, wherein the processor for individual processing is further implemented to remove a region of a microcalcification or to add a further microcalcification.

31. Apparatus according to claim 28, wherein the processor for individual processing is further implemented to divide a region of a microcalcification into a first microcalcification and a second microcalcification.

32. Apparatus according to claim 28, further comprising an evaluation unit, wherein the evaluation unit is implemented to read in the segmentation and to make a probability statement classifying the read-in segmentation as benign or malignant.

33. Apparatus according to claim 32, wherein the evaluation unit is implemented to use a support vector machine for classification.

34. Apparatus according to claim 28, wherein the bandpass filter is implemented to perform wavelet bandpass filtering.

35. Apparatus according to claim 34, wherein the bandpass filter is implemented to use Daubechies-6-wavelets for wavelet bandpass filtering.

36. Apparatus according to claim 28, wherein the processor for individual processing comprises a computer mouse, wherein the computer mouse comprises a mouse wheel and the processor for individual processing is implemented to continuously change the threshold by rotating the mouse wheel.

37. Apparatus according to claim 36, wherein the processor for individual processing is implemented to effect a division of the microcalcification into a first microcalcification and a second microcalcification by clicking on the microcalcification with a mouse button.

38. Apparatus according to claim 28, wherein the bandpass filter comprises a background determiner in the form of a structural element sampler and a subtractor for subtracting a background determined by the background determiner from the mammographic image.

39. Apparatus for segmenting microcalcifications in a mammographic image, comprising:
a structural element sampling filter for filtering the mammographic image to acquire a filtered mammographic image;
marker for marking image points in the filtered mammographic image exceeding or falling below a predetermined threshold for marking potential regions of microcalcifications.

40. Method for segmenting microcalcifications in a mammographic image comprising:
bandpass filtering the mammographic image for acquiring a filtered mammographic image;
marking image points in the filtered mammographic image exceeding a predetermined threshold as a potential region of a microcalcification;
individually processing clusters of adjacent marked image points for changing an extension of clusters such that the clusters represent a segmentation of microcalcifications,
wherein the individual processing is performed such that a region of a microcalcification is manually enlarged or reduced by means of a local change of the predetermined threshold in surroundings of the microcalcification.

41. A tangible computer medium including a computer program comprising a program code for performing, when the computer program runs on a computer, the method for segmenting microcalcifications in a mammographic image, the method comprising:
bandpass filtering the mammographic image for acquiring a filtered mammographic image;
marking image points in the filtered mammographic image exceeding a predetermined threshold as a potential region of a microcalcification;
individually processing clusters of adjacent marked image points for changing an extension of clusters such that the clusters represent a segmentation of microcalcifications,
wherein the individual processing is performed such that a region of a microcalcification is manually enlarged or reduced by means of a local change of the predetermined threshold in surroundings of the microcalcification.

42. Apparatus according to claim 39, wherein the structural element sampling filter is implemented to, for filtering the mammographic picture:
sample a three-dimensional intensity distribution spanned across a row and column direction with a structural element for acquiring a low-pass filtered version of the mammographic picture, which the structural element describes when sampling the three-dimensional intensity distribution,
subtract the low-pass filtered version from the mammographic picture for acquiring a high-pass filtered version of the mammographic picture, and
subject the high-pass filtered version to a low-pass filtering for noise removal in order to acquire a bandpass filtered version of the mammographic picture.

43. Apparatus according to claim 42, wherein the structural sampling filter is implemented such that the structural element is a ball,
the sampling involves rolling the ball across the three-dimensional intensity distribution, and
the low-pass filtered version is described by the center of the ball when rolling across the three-dimensional intensity distribution.

44. Apparatus according to claim 43, wherein the structural sampling filter is implemented such that the ball has a radius larger than a microcalcification diameter, below which are 95% of a distribution of the microcalcification diameters in the mammographic picture.

45. Apparatus according to claim 42, wherein the structural sampling filter is implemented such that the low-pass filtering to which the high-pass filtered version of the mammographic picture is subjected is a Gaussian low-pass filtering.

46. Apparatus according to claim 43, wherein the structural sampling filter is implemented such that the user is enabled to perform bandpass filter boundary adjustment by varying the extension of the structural element by means of rotating a rolling wheel of a computer mouse.

47. Apparatus according to claim 39, further comprising:
a processor for individual processing of one of the regions of adjacent marked image points for changing an extension of the one region for acquiring a segmentation of microcalcifications.

48. Apparatus according to claim 47, wherein the processor for individual processing is implemented to mark surroundings of the microcalcification and to process them differently.

49. Apparatus according to claim 47, wherein the marker is implemented such that the threshold can be adjusted manually.

50. Apparatus according to claim 47, wherein the processor for individual processing is implemented to enlarge or reduce a region of a microcalcification, to remove a region of a microcalcification or to add a further microcalcification, and/or to divide a region of a microcalcification into a first microcalcification and a second microcalcification.

51. Apparatus according to claim 50, wherein the processor for individual processing is implemented to effect enlarging or reducing by means of a local change of the threshold in surroundings of the microcalcification.

52. Apparatus according to claim 50, wherein the processor for individual processing is implemented to effect enlarging or reducing by means of scaling the marked region.

53. Apparatus according to claim 39, wherein the structural element sampler is implemented to determine a low-pass filtered background of the mammographic image by sampling by means of a structural element and to subtract it from the mammographic picture for acquiring a high-pass filtered mammographic picture, and to subject the high-pass filtered mammographic picture to low-pass filtering for filtering out noise from the mammographic picture and for acquiring a bandpass-filtered mammographic picture.

54. Method for segmenting microcalcifications in a mammographic image comprising:
sampling the mammographic image by means of structural elements, and subtracting a background acquired in this manner from the mammographic image for acquiring a high-pass filtered mammographic image;
low-pass filtering the high-pass filtered mammographic image for filtering out high frequent noise portions and for acquiring a filtered mammographic image; and
marking image points in the mammographic image exceeding or falling below a predetermined threshold, for marking potential regions of microcalcifications.

55. A tangible computer readable medium including a computer program comprising a program code for performing, when the computer program runs on a computer, the method for segmenting microcalcifications in a mammographic image, the method comprising:
sampling the mammographic image by means of structural elements, and subtracting a background acquired in this manner from the mammographic image for acquiring a high-pass filtered mammographic image;
low-pass filtering the high-pass filtered mammographic image for filtering out high frequent noise portions and for acquiring a filtered mammographic image; and
marking image points in the mammographic image exceeding or falling below a predetermined threshold, for marking potential regions of microcalcifications.
